(19) United States
(12) Patent Application Publication
(10) Pub. No.: US 2011/0154224 A1
(43) Pub. Date: Jun. 23, 2011

(54) Methods, Systems and Platform Devices for Aggregating Together Users of a TVand/or an Interconnected Network

(75) Inventors: Dan Bates, Manhattan Beach, CA (US); Scott Holmes, Agoura Hills, CA (US); Benjamin Sullivan, San Diego, CA (US)

(73) Assignee: ChatMe TV, Inc., Culver City, CA (US)

(21) Appl. No.: 12/970,062

(22) Filed: Dec. 16, 2010

Related U.S. Application Data
(60) Provisional application No. 61/287,410, filed on Dec. 17, 2009.

(51) Int. Cl. G06F 3/01; G06F 15/16

(52) U.S. Cl. 715/758

(57) ABSTRACT

Described herein are methods, systems, and devices comprising or utilizing a digital processing device comprising an operating system that is configured to read executable instructions for creating at least one contextual-based chatroom that is focused on a topic of interest that is in common between at least a first user (including e.g., a pulled or pushed user) and at least a second user (including e.g., a pulled or pushed user) of an interconnected network.

### CROSS REFERENCE

This application claims the benefit of U.S. Appl. No. 61/287,410 filed Dec. 17, 2009 which is hereby incorporated by reference in its entirety.

### BACKGROUND OF THE INVENTION

Spearheading the technology revolution, the internet has revolutionized the way the average person interacts with the world. At any given point in time, a user of the internet may be interacting over the internet about a topic of interest that, unbeknownst to the user (and potential advertisers that may wish to target the user with specific products or services), a different user of the internet is experiencing or interacting with the same or similar content. So-called “chat rooms” provide internet users with the opportunity for the real-time exchange of information and ideas between members.

### SUMMARY OF THE INVENTION

Described herein is a technology that is capable of dynamically and contextually aggregating users of a network together into a chatroom to interact so that contextual and temporal based message (e.g., an advertisement) is provided directly to the users within the chatroom. Further provided herein are methods, devices, and systems, and software with executable instructions for dynamically assembling chat environments based on keywords and/or key phrases derived from communications of users of an interconnected network and/or derived from broadcast media available to users of the interconnected network, and aggregating and providing contextual and temporal based message (e.g., an advertisement) to users who share a common interest in or have expressed a common desire to interact with other users of the network. Users of the subject matter described herein join the chat environment by either manually pushing to join the chat environment or, in other situations, the methods, devices, systems and/or software with executable instructions provided herein automatically pulls the user into a chat environment.

The subject matter provided herein provides numerous advantages over the existing internet technologies. For example, the subject matter connects and aggregates together like-minded users, for example bloggers, web-surfers, commentators, taggers, publishers of content, television viewers, chatters, and other users of an interconnected network in real-time and across various interfaces, client components, IP networks, and display or platform devices.

The subject matter provided herein directed to the dynamic assemblage of users in real-time across broad domains allows for the contextual and temporal based message (e.g., an advertisement) of goods and services to users of the interconnected network. Moreover, additional features, including for example engagement metrics, ensure that users of the interconnected network that join a chat environment remain in the chat room for an extended period of time. In turn, users and targeting advertisers are drawn to the chat environments described herein, resulting in greater quantity and quality of interactions among users, a longer retention time for users, repeated visits to chatrooms that are topically based and dynamically created, and enhanced advertisement opportunities. A single source of content, for example a video, blog, post, news articles, chat, other broadcast media, communication or other interaction by users of the interconnected network provide the opportunities for users with a common topic of interest to interact.

In one embodiment, the application of temporal context to the delivery of advertisements allows for the display of advertisements to two or more participants in an active chat. In further or additional embodiments, the advertisement is selected and displayed based on tokens representing prior demographics of each user, prior chat history of each user, or cross-correlated tokens across both users. For instance, in some embodiments the advertisement is selected from the subset of types of content that are deemed desirable to both the first and second user. Moreover, in further or additional embodiments, given the prior demographic or metadata descriptions of each user, including user preferences, chat history, language characterizations (e.g., those derived from the lexicon or vocabulary of past chats) used in conjunction or independently of the immediate temporal context of the chat, an advertisement is generated in real time and delivered to two or more users with the express intent to stimulate discussion around the advertisement within the chat. Thus, unlike prior internet advertisements that are relatively static and geared towards a single user, the subject matter provided herein promotes advertisements that would promote group discussion in real-time around a shared set of past or predicted interests. In a specific embodiment, persons using the internet with an interest in surfing are chatting about Kelly Slater's television appearance at Pipeline, and an embodiment of the subject matter provided herein, e.g., the ChatMeTV system, delivers an advertisement to the users of the internet advising them to: “Check out the gnarly waves over at La Jolla Surf Shop man!” which was generated based on (a) a combination of historical characterizations of the user dialects and/or (b) chat history between the users based on prior discussions.

In yet another embodiment, users are chatting about No. 9 and Park and the “rap videos that made the top 10.” In a commercial embodiment of the subject matter provided herein, e.g., the ChatMeTV system, a system recognizes the user's current context of music video and rap interest, and delivers an advertisement meant to stimulate discussion between the participants. For example, in some embodiments, a new Country/Rap Fusion band that is performing in their area replete with suggestive content for their age demographic. The temporal context for advertisements can be augmented by real-time crowdsourcing of data across temporally linked content. In further embodiments, a commercial embodiment of the subject matter provided herein, e.g., the ChatMeTV system, requests content from associated partners to search for advertisements that meet such criteria, for example the performance databases housed at a particular website, including for example, MTV.com, BET.com, HerdIt.org, or CMT.com, and the system then generates a lexicon-specific advertisement simultaneously to the users with the intent to initiate discussion about the advertisement.

In one aspect, provided herein is a system comprising: (a) a digital processing device comprising an operating system that is configured to read executable instructions for creating at least one contextual-based chatroom that is focused on a topic of interest that is in common between at least a first user and at least a second user of an interconnected network, wherein (i) the chatroom contains the first user wherein the first user has manually accessed the chatroom (e.g., with a subscription and/or a geographic location and/or a time) that has been transmitted over the interconnected network (hereinafter referred to as a “pushed user”), (ii) the chatroom contains the second user wherein the second user has been aggregated into the chatroom based on the temporal and contextual activity of the second user in the interconnected network (hereinafter referred to as a “pulled user”), (iii) at least one user in the chatroom has published content within the chatroom, and (iv) a temporal and contextual message (e.g., an advertisement) has been provided to at least one user within the chatroom; and (b) a display device for displaying the chatroom to a user of the interconnected network.

In another aspect, provided herein is a digital processing device comprising an operating system that is configured to read executable instructions for creating at least one contextual-based chatroom that is focused on a topic of interest that is in common between at least a first user (e.g., a pulled or pushed user) and at least a second user (e.g., a pulled or pushed user) of an interconnected network, at least one user in the chatroom has published content within the chatroom, and (ii) a temporal and contextual based message (e.g., an advertisement) has been provided to at least one user within the chatroom. In further or additional embodiments, the device further comprises a display device that is a computer monitor, a television, a smartphone, or an internet appliance.

In some embodiments, the chatroom is created based on the temporal and contextual activity of at least one user within the interconnected network. In further or additional embodiments, the chatroom is created based on the transformed data of temporal and contextual activity of a user of the interconnected network. In still further embodiments, the temporal-based and contextual-based activity is transformed from one or more of the following: an internet page accessed by a user of the interconnected network, the chat depicted on an internet page accessed by a user of the interconnected network, metadata from keyword searching performed by a user of the interconnected network, broadcast media associated with a user within the interconnected network, as well as web pages, metadata, or broadcast media associated with similar microdemographics accessed within the same timeframe as the user. In specific embodiments, the contextual-based chatroom is created based on keywords or keyphrases that have been derived from a broadcast media. In other embodiments, the topic of interest is based on a broadcast media that is in common between at least the first user and the second user of the interconnected network. In still further embodiments, a user has accessed the chatroom by transmitting over the interconnected network the current time. In some embodiments, a user accesses a dynamically created chatroom using a subscription that was transmitted over the interconnected network when a first user manually initiated access to a portal associated with the chatroom.

In further or additional embodiments, a user accesses a chatroom using an interface that further comprises a portal that itself further comprises an electronic programming guide. In some embodiments, the user's subscription was transmitted over the interconnected network when the executable instructions initiated access to a portal associated with the chatroom. In some embodiments, a user of the interconnected network accesses a chatroom using an interface that further comprises a web-based browser, a console, a set-top TV box, a television, an internet appliance, or a smartphone. In some embodiments, a user has been aggregated into the chatroom based on a common interest with a different user in the chatroom. In further or additional embodiments, a user has expressed a desire to interact with the different user in the chatroom. In further or additional embodiments, a user has been aggregated into the chatroom based on filtered temporal and contextual activity of the second user in the interconnected network. In certain embodiments provided herein, a chatroom is displayed on a computer monitor, a television, a smartphone, or an internet appliance.

In another aspect, provided herein is a method comprising the step of transforming temporal and contextual activity of at least a first user and at least a second user of an interconnected network into a topic of interest for a chatroom that is in common between the first user and the second user, wherein (i) the chatroom contains the first user wherein the first user has accessed the chatroom with a subscription and a geographic location that have been transmitted over the interconnected network, (ii) the chatroom contains the second user wherein the second user has been aggregated into the chatroom based on the temporal and contextual activity of the second user in the interconnected network, (iii) at least one user in the chatroom has published content within the chatroom, and (iv) a temporal and contextual message (e.g., an advertisement) has been provided to at least one user within the chatroom.

In another aspect, provided herein is a computer program comprising: (a) a computer program storage device readable by a digital processing system that is connected to an interconnected network; and (b) instructions executable by the digital processing system for creating at least one contextual-based chatroom that is focused on a topic of interest that is in common between at least a first user (e.g., a pulled user) and at least a second user (e.g., a pushed user) of the interconnected network, wherein (i) at least one user in the chatroom has published content within the chatroom, and (ii) a temporal and contextual message (e.g., an advertisement) has been provided to at least one user within the chatroom.

Further provided herein in yet another aspect is a computer program comprising: (a) a computer program storage device readable by a digital processing system that is connected to an interconnected network; and (b) instructions executable by the digital processing system for aggregating one or more user into a chatroom based on the temporal and contextual activity of the user in the interconnected network.

### BRIEF DESCRIPTION OF THE DRAWINGS

A better understanding of the features and advantages of the present invention will be obtained by reference to the following detailed description that sets forth illustrative embodiments, in which the principles of the invention are utilized, and the accompanying drawings of which:

FIG. 1 is illustrative of a non-limiting example of a manually pushed first user entering a chatroom and an aggregated second user that has been pulled into a chatroom, either directly, or indirectly.

FIG. 2 is illustrative of different types of non-limiting client components and steps of the methods, devices, and systems described herein.

FIG. 3 is illustrative of the aggregation of chat feature of the subject matter provided herein.

FIG. 4 is illustrative of a non-limiting embodiment depicting a feature of the methods, devices, and systems described herein whereby users of the same or different interfaces within an interconnected network are aggregated together around common topics of interest.

FIG. 5 is illustrative of the aggregation of users of an interconnected network based on a specific non-limiting example of a topic of interest that is common to the aggregated users of the interconnected network.

FIG. 6 is illustrative of the aggregation of a user of a browser based device with a user of a display or platform based device.

### DETAILED DESCRIPTION OF THE INVENTION

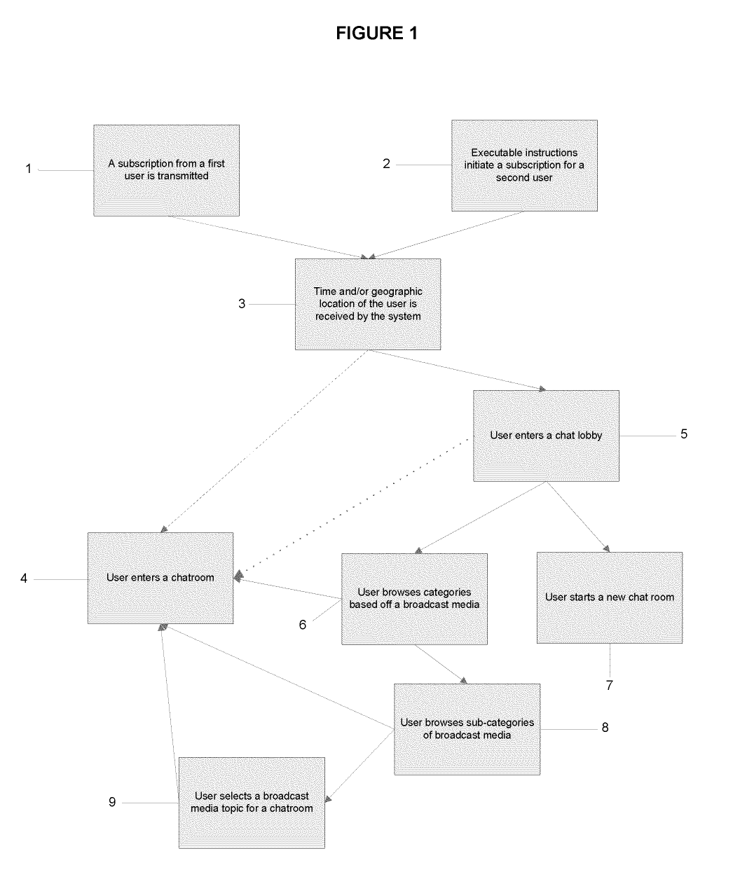

Referring to FIG. 1, illustrated is a non-limiting schematic for one embodiment of the systems, methods and devices provided herein wherein a subscription 1 is received from a first user whereby the first user initiated the steps to enter a chatroom. The first user in this situation is said to be manually “pushed” into the chatroom. In other situations where the first user did not initiate the steps to enter the chatroom, the first user is said that have been pulled into the chatroom (not shown). Also shown is a second user that has been aggregated into the chatroom whereby executable instructions have initiated a subscription for the second user 2. In this situation, the second user is said to be automatically “pulled” into the chatroom. It is understood that in certain situations a specific chatroom contains only pushed users, only pulled users, or a combination of pushed and pulled users. The time and/or geographic location of the first and second users is then transmitted 3 to a receiver (not shown). In certain situations, a user then automatically enters a chatroom 4, or a user may enter a chat lobby 5. The user that enters a chat lobby then has the option to either browse categories based on a broadcast media 6, start a new chat room 7, in which the user then enters into the new chat room, or directly enter a preexisting chatroom 4. The browsing user 6 then has an option to either further browse subcategories 8, or enter a preexisting chatroom 4. The sub-browsing user then has the option to select a specific broadcast media topic for chatroom 9, in which case the user enters that chatroom, or the sub-browsing enters a chatroom 4 based on the sub-category chosen by the sub-browsing user. It is understood that in some embodiments, multiple chatrooms are provided, and it is understood by a person of skill in the art that a user has options to enter a plurality of chatrooms at any given moment.

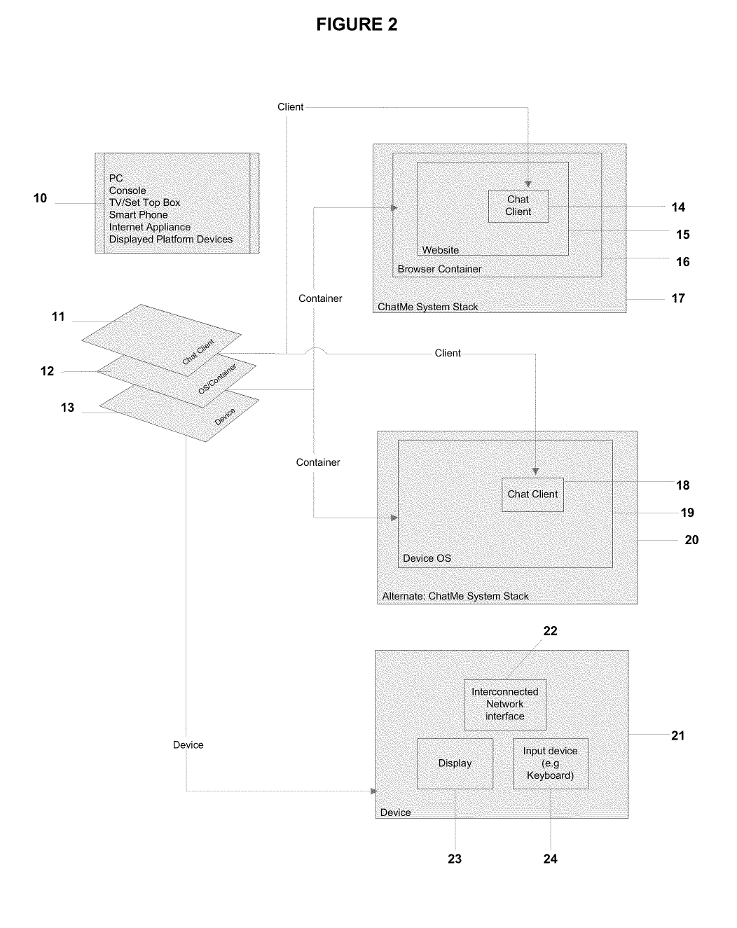

Referring to FIG. 2, provided is a schematic for one embodiment of the client components and steps for the methods, devices and systems described herein, including display and platform devices 10, including a personal computer, a gaming console, a TV, a TV set top box, a smart phone, and an internet appliance.

In some embodiments, the display and/or platform device depicts television (TV), including high definition television (HDTV) to a user. In certain embodiments, television programming is provided to a user through traditional radio frequency broadcast, satellite signal, cable television (CATV) format and/or via the internet.

In further or additional embodiments, the display and/or platform device is an Internet Protocol television (IPTV). An IPTV is a system and method through which Internet television services are delivered using the architecture and networking methods of the Internet Protocol Suite over a packet-switched network infrastructure, e.g., the Internet and/or broadband Internet access networks. In additional embodiments, provided is an IPTV-enabled television, set-top box, or like device that is configured to display live television with interactivity related to a TV show that users optionally use as the subject of a chat discussion. In further or additional embodiment, provided is an IPTV-enabled device that depicts time-shifted programming. In some embodiments, the time-shifted programming is catch-up TV (replays a TV show that was broadcast hours or days ago, e.g. a DVR), and in further or additional embodiments the time-shifted programming is start-over TV (replays the current TV show from its beginning). In still further embodiments, described herein is an IPTV-enabled television, set-top box, or like device that is configured to display video on demand (VOD), an internet browser, internet websites, a catalog of videos (related or unrelated to TV programming), or specific user applications (e.g. Netflix, Pandora, Youtube, and the like) for the IPTV. For example, in some embodiments, the specific user application is an IPTV application configured to enable aggregation of users into a chat room as described herein.

In some embodiments, the IPTV is an Apple TV™, which is a digital media receiver set-top box for IPTV that is commercially available from Apple Inc. In further or additional embodiments, the IPTV is a Google TV™, which is commercially available as a set-top box or integrated IPTV in a television and that is commercially available from Sony, Inc., Intel, Inc., Google, Inc., and Logitech, Inc. In further or additional embodiments, the IPTV is a set-top box or integrated television from Roku (Roku, Inc.), Boxee (Boxee, Inc.), or Hulu (Hulu, Inc.). In further or additional embodiments, the IPTV is an integrated HDTV television from Vizio, Inc. or Toshiba, Inc. In some embodiments, the display and/or platform device is configured for place-shifting audio and video content over an internet connection and is referred to as a so-called place-shifting device. A place-shifting device, in certain situations, enables a user to view audio and video content (including television programming) at numerous locations rather than the traditional single or more limited location(s). For example, in certain embodiments, provided is a display and/or platform device of a user that is configured to place-shift audio and/or video content over a broadband Internet connection. For example, in certain situations, the place-shifted content comprises video streams from a user's home television or set-top box, DVR or other video source (such as a DVD player or home security camera) forwarded for viewing remotely by the user on a computer, netbook or mobile phone at any location wherein the user has a high-speed Internet connection or cellular data network. In some embodiments, the place-shifted content is live, and in other embodiments the place-shifted content is recorded content (such as with a DVR)). Thus, the chat and content applications described herein can be enjoyed both within the home on the home network or away from home via the Internet. In some embodiments, the place-shifting device is a TV2ME (K2B, Inc.), a Slingbox (Sling Media, Inc.), a Location Free device (Sony), or a HAVA device (Monsoon, Inc.).

Also depicted is the interoperability of the chat client 11, the operating system or container 12, and the display or platform device 13. Also provided is a specific embodiment wherein a chat client 14 is depicted on a website 15 within a web browser or container 16, whereby 15 and 16 comprise a chatme system stack 17. By way of another non-limiting example, provided is a chat client 18 operated on an operating system 19, whereby 18 and 19 comprise a chatme stack 20. Provided further in FIG. 2 is a non-limiting example of a display or platform device 21 comprising an interconnected network interface 22, a display 23, and an input device 24, for example a keyboard optionally with a mouse. In some embodiments, the input device for chat functionality further comprises a keyboard for controlling at least television programming or other audio and video content (for example, that is the subject of the chat conversation).

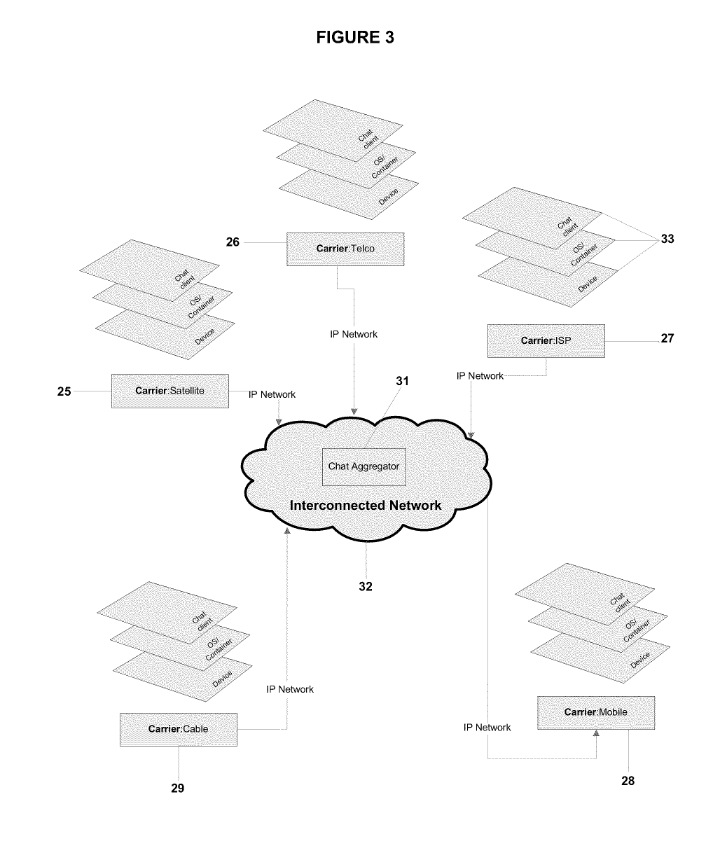

Next, FIG. 3 is illustrative of the aggregation of chat feature of the methods, devices, and systems described herein demonstrating the various non-limiting IP carriers and client components and steps provided herein. Exemplary carriers include, but are not limited to, satellite 25, telecommunications 26, including fiber optic lines, ISP 27, a mobile network 28, for example 3G or 3GS, the internet, and/or a cable 29, including for example coaxial cable. Each carrier comprises a client component or steps 30, which is depicted in exemplary fashion for the ISP IP network. The aggregation of chat feature 31 of the subject matter described herein is configured to aggregate or scrape users of the interconnected network 32 into a common portal or interface of chatrooms. Users of the interconnected network (not shown), in certain embodiments are pulled into a chatroom, either directly or indirectly. In further or additional embodiments, users are pushed into a chatroom, either directly or indirectly.

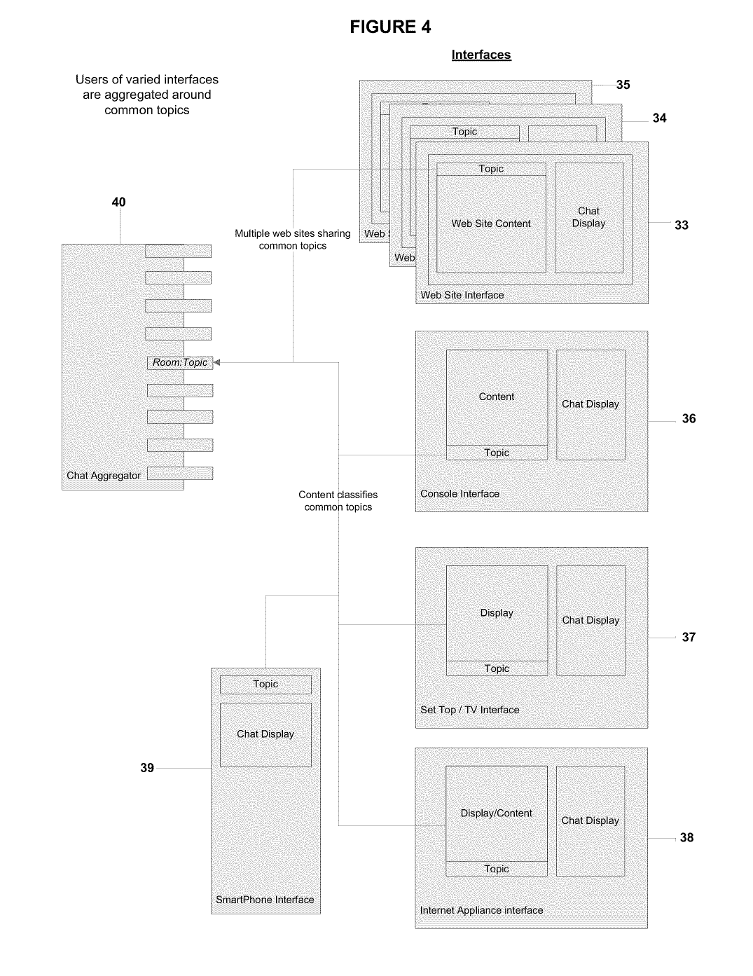

Referring now to FIG. 4, a user (not shown) of a website interface 33 is associated with a topic of interest (contextually based on a website, broadcast media or a communication, and including as specific examples viewing, blogging, chatting, or other form of communication about or surrounding the topic or interaction associated with a broadcast media) that is in common with a topic associated with other users within the interconnected network, for example other users of a website interface 34 or 35 who are associated with the common topic of interest. In this example, these users are aggregated together into a chatroom 40 either directly or indirectly, and either by pulling or being pushed, for the dynamic exchange of communication and broadcast media about the common topic of interest. Other users of the network are also associated with the common topic, and they too in certain situations are aggregated into a chatroom, either directly or indirectly, and either by pulling or being pushed, to provide for the dynamic interaction with other users with similar interests. Users of a console interface 36, for example a gaming console interface in certain embodiments are playing a video game that is associated with the common topic of interest. In further or additional embodiments, users of a TV or TV set top box 37 are associated with the common topic of interest, for example by viewing and/or chatting about the common topical material. Other users, for example users of an internet appliance 38, for example an iPod, are also associated with the common topic of interest for example by listening to music that is directed to the common topic of interest. All users of the interconnected network that share a common topic of interest, or in certain embodiments users that have expressed a desire to interact with other individuals of a particular topic of interest, are dynamically assembled together into one or more chat rooms based on key words or key phrases derived from any communication, website, and/or form of broadcast media.

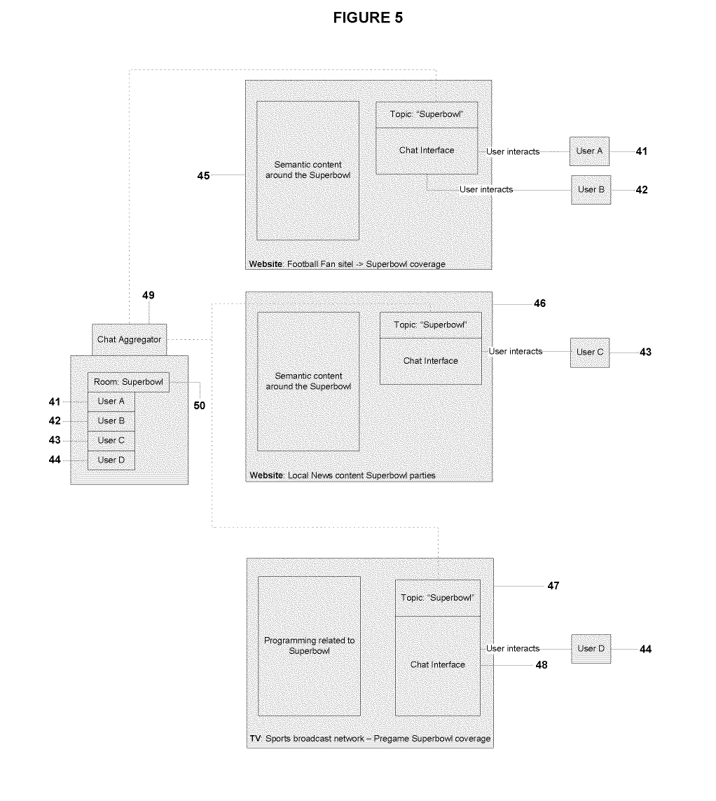

Referring next to FIG. 5, provided is a specific non-limiting embodiment illustrating the superbowl as a common topic of interest among four users, user A 41, user B 42, user C 43, and user D 44. User A 41 and User B 42 are interacting with each other on a football fan website 45 with the exchange of broadcast media and/or chat about the superbowl on a website. User C 43 is on a different website, one focused on the local news focused on superbowl parties 46. User D 44 is watching pregame superbowl coverage on a sports broadcasting network 47, for example ESPN on a TV that is equipped with a chat interface 48. A feature of the subject matter provided herein is that user A 41, user B 42, user C 43, and User D 44 are aggregated together 49 into one or more chatrooms 50 either directly or indirectly, and either by pulling or being pushed, for the dynamic exchange of communication and broadcast media about the common topic of interest, which in this non-limiting illustration is the superbowl.

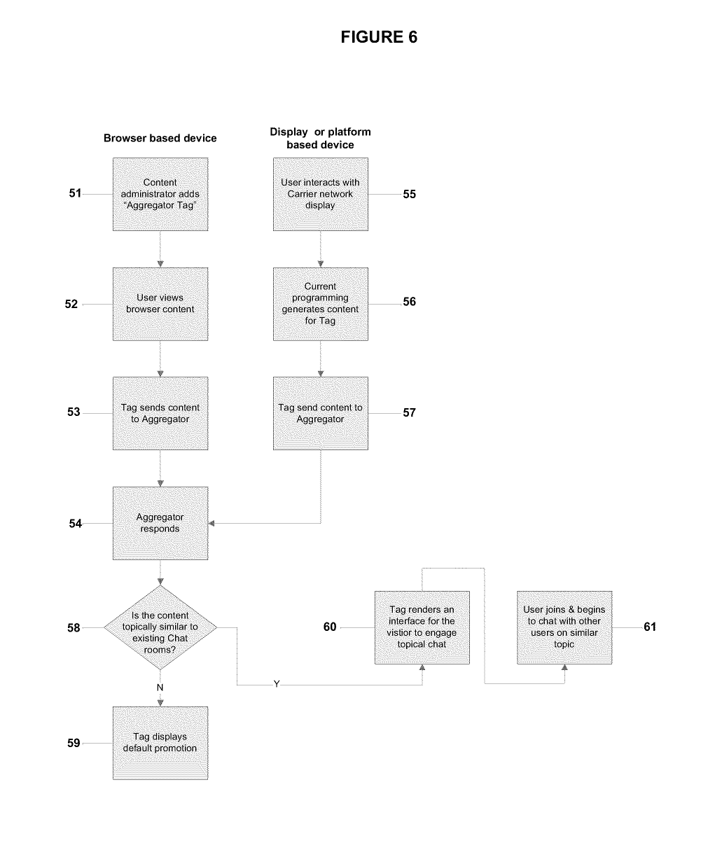

Referring now to FIG. 6, a content administrator adds an aggregator tag to content 51. A user then views the browser content 52. The aggregator tag then sends content to the aggregator feature 53 of the system, device or method. The aggregator feature then responds 54 to the aggregator tag. A different user interacts with a carried network display 55. In this case, the current programming generates content for an aggregator tag 56. The tag then sends content to the aggregator feature 57. The aggregator feature then responds to the aggregator tag 54. The system, devices, and methods described herein then provide a feature to determine whether the content associated with the users is topically similar to a topic of interest of an existing chatroom 58. If the content is dissimilar, the tag displays the default promotion 59. However, if the content is similar, then the tag renders an interface for the user to engage in topical chat 60. The user then joins the chatroom and begins to exchange broadcast media and communication with other users in the chatroom 61.

### Dynamic Creation of the Chatroom

A first feature of the subject matter provided herein is the dynamic creation of a chatroom that is focused on a topic of interest that is in common between at least a first user (e.g., a pushed or pulled user) and at least a second user (e.g., a pushed or pulled user) of an interconnected network. In some embodiments, the dynamically created chatroom is created based on the temporal and contextual activity of the at least one user (e.g., a pushed or pulled user) within the interconnected network. In further or additional embodiments, the chatroom is created based on the transformed data of temporal and contextual activity of a user (e.g., a pushed or pulled user) of the interconnected network. In still further embodiments, the temporal-based and contextual-based activity is transformed from one or more of the following: an internet page accessed by a user (e.g., a pushed or pulled user) of the interconnected network, the chat depicted on an internet page accessed by a user (e.g., a pushed or pulled user) of the interconnected network, the meta-data from keyword searching performed by a user (e.g., a pushed or pulled user) of the interconnected network, or a broadcast media associated with a user (e.g., a pushed or pulled user) within the interconnected network. In yet additional embodiments, the contextual-based chatroom is created based on keywords or keyphrases that have been derived from a broadcast media. In some embodiments, a topic of interest is based on a broadcast media, website page, communication, or other content available to a user (e.g., a pushed or pulled user) of the interconnected network that is in common between at least the first user (e.g., a pushed or pulled user) and the second user (e.g., a pushed or pulled user) of the interconnected network.

“Broadcast media” as used herein, includes t that is audio and/or visual programming and other content (e.g., television, radio, movies, images, pictures, and the like), blog content, content from social networking websites (e.g., facebook, myspace, and the like), youtube, and other forms of content provided by a user (e.g., a pushed or pulled user) or entity and made available to others over the interconnected network, for example the internet, or through television.

### Users Accessing the Chatroom

A second feature of the subject matter provided herein is the accessibility of users of an interconnected network to a chatroom. In some embodiments, a chatroom contains a first user wherein the first user has accessed the chatroom with a subscription, a geographic location, and/or a current time (optionally including the time zone) that has been transmitted over an interconnected network. As used herein, a “subscription” means initiating the step to enter into the chatroom and includes situations where the user is both pushed into the chatroom (user initiates steps to join, e.g., by accessing the home website, such as, but not limited to, the ChatMeTV home website) and also includes situations where the user is pulled into the chatroom (e.g., the executable instructions initiate contact to a user within the interconnected network other than through the home website (e.g., when the user is on a website that is not the home website)). In some embodiments, the first user in the chatroom is pushed into the chatroom. It is to be understood that such a chatroom optionally includes any plurality of pushed or pulled users. In further or additional embodiments, a first user is pulled into the chatroom, and optionally a different user is later pushed or pulled into the chatroom. In further or additional embodiments, a user accesses the chatroom using an electronic programming guide that is displayed on an interface, including for example a web-based browser, a console, a set-top TV box, a television, an internet appliance, or a smartphone.

### Aggregation

A third feature of the subject matter provided herein is the contextual and temporal analyses, transformation, and detection of content including for example broadcast media, websites and communications among users, that is available on an interconnected network, for example the internet or an intranet, to provide topics of interest for discussion that are common to uses of the interconnected network and dynamic, targeted message (e.g., advertisement) opportunities. In turn, the aggregation of an audience from multiple sources and domains provides a unique experience to the user of a chatroom.

Accordingly, in some embodiments, a chatroom contains a first and second user and the second user has been aggregated into the chatroom based on the temporal and contextual activity of the second user in the interconnected network. In further or additional embodiments, a second user has been aggregated into the chatroom based on a common interest with a different user in the chatroom. In further or additional embodiments, a second user has expressed a desire to interact with the different user in the chatroom.

### Temporal and Contextual Based Messaging (e.g., Advertisement)

A fourth feature of the subject matter provided herein is conversational data mining. In some embodiments, the conversational data mining feature mines the conversations and publication of content occurring in the chatroom in real-time for relevant topics that may pertain to a product, including goods and services, or a brand advertiser, thereby providing for the temporal and contextual based message (e.g., an advertisement) of goods and/or services to users of chatroom. In some embodiments, provided herein is a method, device, system, and associated executable code that mines conversations and published content occurring in a chatroom for key words, phrases, brand, or product content, for example a user's chat referencing the product or brand explicitly by content, or implicitly by context. As used herein, “published content” refers to any form of communication from a user within the chatroom. For example, in some embodiments, published content refers to chat, broadcast media, including video and pictures, symbols, music, and the like that are communicated by the user to others within the chatroom.

In further or additional embodiments, provided herein is the dynamic advertisement of products and/or services to users within the interconnected network that is pertinent at that time to the subject matter of the user's interaction with the chatroom. In some embodiments, the software provides for the temporal, contextual, and non-licensed message (e.g., an advertisement) regarding products or services to a user within the chatroom. In some embodiments, the products or services advertised to at least one user within the chatroom is not authorized by the provider of the broadcast media. Accordingly, also provided herein is a method of providing, in real-time, a message (e.g., an advertisement) to a user comprising transforming the activity of the user within the interconnected network.

### Optional Module: Similarity Engine and Specificity Slider

An optional feature of the subject matter provided herein is a similarity engine. The similarity engine is utilized to contextually match a piece of content with others within the interconnected network. In particular, the similarity engine is based on a modified vector space model where the “top terms” from each piece of content are extracted and stored as a vector along with key pieces of metadata ranking the relative importance of a portion of the content piece, for example a document, website, communication of a user, or a broadcast media. Weights are then assigned to each portion of content, for example to each term in a document, based on the uniqueness of that portion of content within the content dictionary, and the importance of that portion of the content within the content as a whole. A similarity score between two or more pieces of content is then calculated by taking the dot product of the content vectors.

In some embodiments, a user is aggregated into a chatroom based on filtered temporal and contextual activity of content in the interconnected network. In some embodiments, the content is a communication from a user, a website, a broadcast media, or other form of content. In further or additional embodiments, the user configures a profile assigned to them to aggregate the user with only highly specific users (referred to as the specificity slider set on high), thereby casting a more narrow, but more specific net of potential users to interact with. In other embodiments, a user configures the profile to have a lower specificity slider position, thereby aggregating the user with a broader and more general range of potential users to interact with in the chatroom. The position of the specificity slider, in further embodiments, is utilized to provide contextual and temporal based advertisement of goods and services to the user.

### Optional Module: Moderation Tools

Another optional feature of the subject matter provided herein is the moderation of the discussion in a chatroom thereby providing an enhanced user experience. For example, in some embodiments, the moderation feature controls the users by banning the user from the chatroom, warning the user in the chatroom, or flagging the user to other users in the chatroom. In further or additional embodiments, the moderation feature indicates that there is at least one chatroom of interest that is open. In other embodiments, the moderation feature indicates how many users are in a particular chatroom.

In particular embodiments, the moderation feature pauses the flowing text thread in the chatroom for the opportunity for users to critically evaluate the discussion. In other embodiments, the moderation feature permits a moderator of the chatroom to clear inappropriate, cumulative, or unwanted text.

In still further embodiments, the moderation feature provides a reporting tool for users of the chatroom. For example, in some embodiments, the reporting tool tracks the total users, monitors the time each user spends in the chatroom, the amount of messages chatted, the average messages per user, and the number and type of advertisements served. This information in turn provides valuable leads and commercial data to advertisers.

In embodiments provided herein, the methods, devices, systems, and executable instructions provided herein optionally further comprising an optional module.

### Other Optional Features

An optional feature of the methods, devices and systems embodying the subject matter described herein is a display device that is a computer monitor, a television, a smartphone, an internet appliance, or combination of two or more of the aforementioned devices. Also provided herein are methods, devices, and systems optionally using a carrier for the interconnected network(s) described herein that is satellite, telecommunications (including fiber optic lines and wireless communications), ISP, a mobile network (for example 3G or 3GS), and cable (including for example coaxial cable).

1. A system comprising:
(a) a digital processing device comprising an operating system and executable instructions for the operating system to create at least one contextual-based chatroom that is focused on a topic of interest that is in common between at least a first user and at least a second user of an interconnected network, wherein
(i) the chatroom contains the first user wherein the first user has accessed the chatroom,
(ii) the chatroom contains the second user wherein the second user has been aggregated into the chatroom based on the contextual activity of the second user in the interconnected network,
(iii) at least one user in the chatroom has published content within the chatroom,
(iv) a temporal and contextual message has been provided to at least one user within the chatroom; and
(b) a display device for displaying the chatroom to a user of the interconnected network.

2. A digital processing device comprising an operating system and executable instructions for the operating system to create at least one contextual-based chatroom that is focused on a topic of interest that is in common between at least a first user and at least a second user of an interconnected network, wherein
(i) the chatroom contains the first user wherein the first user has accessed the chatroom with a subscription and a geographic location that have been transmitted over the interconnected network,
(ii) the chatroom contains the second user wherein the second user has been aggregated into the chatroom based on the temporal and contextual activity of the second user in the interconnected network,
(iii) at least one user in the chatroom has published content within the chatroom, and
(iv) a temporal and contextual message has been provided to at least one user within the chatroom.

3. The device of claim 2 further comprising a display device that is a computer monitor, a television, a smartphone, or an internet appliance.

4. A computer program comprising:
(a) a computer program storage device readable by a digital processing system that is connected to an interconnected network; and
(b) instructions executable by the digital processing system for creating at least one contextual-based chatroom that is focused on a topic of interest that is in common between at least a first user and at least a second user of the interconnected network, wherein
(i) the chatroom contains the first user wherein the first user has accessed the chatroom with a subscription and a geographic location that have been transmitted over the interconnected network,
(ii) the chatroom contains the second user wherein the second user has been aggregated into the chatroom based on the temporal and contextual activity of the second user in the interconnected network,
(iii) at least one user in the chatroom has published content within the chatroom, and
(iv) a temporal and contextual message has been provided to at least one user within the chatroom.

5. The computer program of claim 4 wherein the chatroom is created based on the temporal and contextual activity of the at least one user within the interconnected network.

6. The computer program of claim 5 wherein the chatroom is created based on the transformed data of temporal and contextual activity of a user of the interconnected network.

7. The computer program of claim 6 wherein the temporal-based and contextual-based activity is transformed from one or more of the following: an internet page accessed by a user of the interconnected network, the chat depicted on an internet page accessed by a user of the interconnected network, the meta-data from keyword searching performed by a user of the interconnected network, or a broadcast media associated with a user within the interconnected network.

8. The computer program of claim 4 wherein the contextual-based chatroom is created based on keywords or keyphrases that have been derived from a broadcast media.

9. (canceled)

10. (canceled)

11. The computer program of claim 4 wherein the subscription was transmitted over the interconnected network when the first user manually initiated access to a portal associated with the chatroom.

12. The computer program of claim 9 wherein the portal further comprises an electronic programming guide.

13. The computer program of claim 4 wherein the subscription was transmitted over the interconnected network when the executable instructions initiated access to a portal associated with the chatroom.

14. The computer program of claim 13 wherein the portal further comprises an electronic programming guide.

15. The computer program of any of claim 14 wherein the portal is displayed on a web-based browser, a console, a set-top box, a television, an internet appliance, or a smartphone.

16. The computer program of claim 4 wherein the second user has been aggregated into the chatroom based on a common interest with a different user in the chatroom.

17. The computer program of claim 16 wherein the second user has expressed a desire to interact with the different user in the chatroom.

18. The computer program product of claim 4 wherein the second user has been aggregated into the chatroom based on filtered temporal and contextual activity of the second user in the interconnected network.

19. The computer program of claim 4 wherein the chatroom is displayed on a computer monitor, a television, a smartphone, or an internet appliance.

20. The computer program of claim 4 wherein the published content is a communication from a user in the chatroom.

21. The computer program of claim 4 wherein the topic of interest is based on a television program.

22. A method comprising the step of transforming temporal and contextual activity of at least a first user and at least a second user of an interconnected network into a topic of interest for a chatroom that is in common between the first user and the second user, wherein
(i) the chatroom contains the first user wherein the first user has accessed the chatroom with a subscription and a geographic location that have been transmitted over the interconnected network,
(ii) the chatroom contains the second user wherein the second user has been aggregated into the chatroom based on the temporal and contextual activity of the second user in the interconnected network,
(iii) at least one user in the chatroom has published content within the chatroom, and
(iv) a temporal and contextual message has been provided to at least one user within the chatroom.

23. (canceled)
